(19) United States
(12) Patent Application Publication
(10) Pub. No.: US 2008/0059086 A1
(43) Pub. Date: Mar. 6, 2008

(54) System and method for determining and detecting stability loss in structures

(76) Inventors: Ziyad Duron, Claremont, CA (US); Loland Alex Pranger, Gaithersburg, MD (US); Zach Lupei, Oak Park, IL (US); Gregory Nielsen, Colton, CA (US); Casey Schilling, Irvine, CA (US)

Correspondence Address: BARTUNEK & BHATTACHARYYA, LTD., 10420 LITTLE PATUXENT PARKWAY, SUITE 405, COLUMBIA, MD, 21044-3533, US

(21) Appl. No.: 11/788,751

(22) Filed: Apr. 21, 2007

Related U.S. Application Data
(63) Continuation-in-part of application No. 10/942,626, filed on Sep. 16, 2004, now Pat. No. 7,228,240.
Application No. 10/942,626 is a continuation-in-part of application No. 10/081,649, filed on Feb. 21, 2002, now Pat. No. 6,807,862.

(51) Int. Cl. G01M 7/00; G01M 19/00

(52) U.S. Cl. 702/56; 73/594

(57) ABSTRACT

A significant number of rescue workers are killed or injured each year as they conduct searches within damaged or burning structures, unaware that the structure is unstable. The present invention provides a system and method for real-time detecting and monitoring structural instability that may lead to inevitable collapse of a structure. The system is capable of displaying data, including visual and/or audible signals, indicating structural instability. Additionally, the present invention is also directed to stability monitoring analysis processes for determining structural stability or instability.

This application is a continuation-in-part of U.S. Pat. No. 6,807,862, issued Oct. 26, 2004, and U.S. Ser. No. 10/942,626, filed Sep. 16, 2004.

### STATEMENT OF GOVERNMENT INTEREST

As outlined under 37 CFR 401.14(b), the United States government shall have a nonexclusive, nontransferable, irrevocable, paid-up license to practice or have practiced for or on behalf of the United States the subject invention.

### BACKGROUND OF THE INVENTION

Structural damage leading to collapse has resulted in injuries and death to rescue workers and others within the vicinity of the collapse. In many rescue operations, the condition of the structure plays a relatively minor role in deciding when and how to enter the structure, particularly if human lives are in danger. The typically complex nature of how damage propagates and may ultimately weaken a structure has made it very difficult to predict imminent collapse. Visual inspections alone, especially during firefighting operations, cannot guarantee detection of mechanisms that could lead to collapse and loss of life. A need exists, therefore, for a technical approach that can monitor structures for structural stability to assess a risk of collapse.

It is important to note that there are significant differences between damage detection, stability monitoring and collapse monitoring. With respect to structures, damage detection is an event indicator of what has happened to that structure, but not necessarily a good indicator of structural stability.

Collapse monitoring, however, is based on the premise that the degree of damage to the structure is so severe that continued exposure to the current loading condition will lead to imminent collapse. A burning structure is, by definition, already damaged due to the fire. The ability to simply detect and track damage mechanism due to fire does not provide a mechanism that will detect impending collapse.

Structural damage detection research is best characterized as using nondestructive testing techniques to determine the behavior of response characteristics under known loading conditions. The selection of the particular testing technique, however, plays a large role in the effectiveness of the detection technique. Prior art damage detection devices and methodologies do not provide accurate testing systems and methods for stability monitoring.

Existing devices that detect damage in structures rely mainly on approaches that induce high frequency or acoustic energy into the structure or that use monitoring devices at critical locations within a structure.

U.S. Pat. No. 5,675,809 to Hawkins, for example, discloses a passive strain gauge that can be mounted to buildings. The gauge emits acoustic waves commensurate with load bearing stress exerted on a building in earthquakes and the like. Similarly, U.S. Pat. No. 5,404,755 to Olson, et al., discloses a method of testing stress in wood and other products using ultrasonic frequencies.

These types of gauges and methodologies operate over a wide frequency range, well beyond those associated with structural resonances. As such, they are not effective in isolating structural response behavior and do not possess the sensitivity required for structural stability monitoring.

U.S. Pat. No. 6,138,516 (to Tillman) discloses a device that monitors the amount of shock applied to a location on a structure. The device is a shock detector and utilizes an accelerometer adapted to generate a rectified signal that is compared to a threshold level to produce a high voltage state. Detection of shock on a structure, however, cannot be used for monitoring structural response leading to collapse, particularly since Tillman utilizes a set threshold level below which the device remains in a low voltage state.

Damage detection based on changes in system identification parameters is well documented in the literature. See Farrar, Cr., An Overview of Modal-Based Damage Identification Methods, Proc. Of DAMAS, June 1997. A considerable number of attempts were made in the late 1990s to develop damage detection algorithms based on the premise that system parameters, being functions of the physical properties of the structures, change as changes in structural stiffness occur. Early work focused on examining changes in resonant frequencies and damping to detect damage in large civil structures (e.g. bridges). However, these parameters proved to be insensitive to lower levels of damage and did not provide clear indications of the location or extent of damage. A study on a steel stringer bridge, in which significant damage was introduced, resulted in a negligible shift in resonant frequency. See Duron, A proposed Field Diagnostic Procedure for Steel Stringer Bridges, Proceedings, 2^{nd} World Conference of Structural Control, Kyoto, Japan, June 1998. Based on the literature and experience, use of ambient excitation for purposes of health monitoring of structures is suspect. This is particularly true when monitoring system parameters that are insensitive to low levels of damage. Damage detection is difficult since low levels of damage can be masked in any structure, and although changes in resonant frequencies may be detected, the relationship to damage is unclear and requires significant insight into the structure itself.

U.S. Pat. No. 5,526,694 (to McEachern, et al.) describes and claims a non real-time approach that is based on extended monitoring times (approaching 48 hours) in order to obtain sufficient data quality that can be used to examine structural resonant characteristics. These results are used for damage detection. While McEachern, et al., state that ambient responses in structures can be detected to below 10 Hz, they utilize an accelerometer having capability to detect environmental vibrations over the 20 to 2000 Hz frequency range. Furthermore, McEachern, et al., discuss the removal of zero-frequency and near-zero frequency acceleration using any well-known algorithm. Therefore, McEachern, et al., provide minimal resolution of acceleration in the time domain due to the low sampling rate of 25 samples per second and the 10 Hz frequency cutoff using an accelerometer that is able to reproduce vibrations in the 20-2000 Hz range.

U.S. Pat. No. 6,292,108 (to Straser, et al.) is directed to a wireless monitoring system that can be installed in existing structures to measure non real-time acceleration responses during extreme events and for periodic structural monitoring purposes. This patent extends prior art technology by incorporating wireless and MEM sensor technologies into a single package. The system provides near real-time condition assessment for “extreme events” and can also be used for periodic monitoring purposes. The system consists of a plurality of self powered sensor units and a site master unit designed to capture the mechanical vibrations that are local to each installation. The practical application of Straser, et al., requires that a number of tasks and experiments . . . be done.” Straser, et al., suggest that the number and location of sensors installed in a structure should be informed by a modal analysis or field test of the structure. “In practice, the preinstallation process may involve iterative testing, modeling and analysis.” For monitoring extreme events such as an earthquake, Straser, et al., require all system computations be performed within 5 to 10 minutes. Further, Straser, et al., suggest a strategy that focuses “on instrumenting the structure at every floor or at a minimum, every few floors.” Straser, et al., go on to state, “The implication is that the instrumentation should be spread throughout the structure to cover as many damage locations as possible.” Straser, et al., discuss the device's expected performance in an extreme event in, terms of the number of bits to be transmitted and the total time required to complete its operation. As described, the device would acquire 2 minutes of actual event response and would consume 14 minutes of acquisition, transmission and archival procedures. In summary, the device of Straser, et al., acquires response information after 16 minutes and requires an additional 4 minutes to complete pre-programmed analytical procedures. Therefore, Straser, et al., describe a device that requires an estimated 20 minutes to complete a monitoring cycle. Effective implementation of Straser's device requires a prior knowledge of structural behavior and a number of strategically placed sensors inside the structure, which produce indication of structural performance over a 20 minute interval.

The need for determining impending structural failure continues to be significant. U.S. Pat. No. 6,807,862 and U.S. Ser. No. 10/942,626 address real time collapse monitoring and are incorporated herein by reference. The present invention provides a new and unique device and method for determining structural damage and imminent failure based on real-time stability monitoring, which will help to prevent injuries and save the lives of rescue workers.

### SUMMARY OF THE INVENTION

It is, therefore, an objective of this invention to provide a real-time system and method for determining the stability changes in a structure undergoing an event induced vibration.

It is another objective of this invention to provide a method of tracking natural frequencies of a structure as it changes of the life of the event/burn.

It is another objective of this invention to provide a method of utilizing the health of a burning structure and the tracked natural frequencies to determine an index of pending collapse.

### DESCRIPTION OF THE FIGURES

The application file contains at least one drawing executed in color. Copies of this patent application with color drawing(s) will be provided by the Office upon request and payment of the necessary fee.

FIG. 1 shows the mounting plate of the present invention.

FIG. 2a shows a healthy transient response.

FIG. 2b shows a weak transient response.

FIGS. 3a and 3b show a second order elliptical bandpass filters

FIG. 4 shows location of representative noise profiles on a frame burn.

FIG. 5a shows constant valued resonances from a healthy structure.

FIG. 5b shows frequency shifts for a structure over time.

FIG. 5c shows result of removing noise profile from an undamaged, excited structure.

FIG. 6a shows the unprocessed spectral content of a frame burn showing frequencies from 0 to 250 Hz.

FIG. 6b shows the unprocessed spectral content of the same frame burn showing frequencies up to 430 Hz.

FIG. 6c shows frequencies from 0 to 2500 Hz after ambient noise reduction using the first profile.

FIG. 6d shows the same region as FIG. 6b after noise reduction using the first profile.

FIG. 6e shows frequencies from 0 to 2500 Hz after attenuating frequencies using the second profile.

FIG. 6f shows the same region as FIG. 6d where healthy resonances are reduced.

FIG. 7a shows the multi-component signal with riding wave and non-constant offset.

FIG. 7b shows the local extrema to create a signal envelope.

FIG. 7c shows the mean of the spline envelope.

FIG. 7d shows the first Intrinsic Mode Function.

FIG. 8 shows structural acceleration response from a burning test frame.

FIG. 9 shows the first fine intrinsic mode functions of the acceleration record u.

FIG. 10 shows normalized average instantaneous frequency and magnitude for a sample burn data.

FIG. 11 shows partial average instantaneous frequency for sample burn data.

FIG. 12a shows five frame burns.

FIG. 12b shows two tow-story frames.

FIG. 12c shows a singe-story space frame.

FIG. 13a shows posts and frames positioned for easy removal.

FIG. 13b shows a fined set of two frames.

FIGS. 14a and 14b show stiff connections between column and beam braces.

FIG. 15a shows a data acquisition system.

FIG. 15b shows a data filter box.

FIG. 15c shows a processor.

FIG. 16a through FIG. 16j show frame burn accelerometer and torch locations.

FIG. 17 shows a completed frame burn set up.

FIG. 18a shows frequency vs. time histories of a frame.

FIG. 18b shows frequency vs. time histories of a second frame.

FIG. 19 shows decreasing frequency using the Wavelet Transform approach.

FIG. 20a shows decreasing frequency using Instantaneous Frequency approach for a frame.

FIG. 20b shows decreasing frequency using Instantaneous Frequency approach for a second frame.

FIG. 21a shows decreasing frequency using the EMD approach for a frame.

FIG. 21b shows decreasing frequency using the EMD approach for a second frame.

FIG. 22 shows a set-up for a two-story burn.

FIG. 23a shows decreasing frequency using the Wavelet Approach.

FIG. 23b shows decreasing frequency using the Instantaneous Frequency Approach.

FIG. 23c shows decreasing frequency using the EMD Approach.

FIG. 24 shows a 3D burn with progressive collapse events.

### DETAILED DESCRIPTION OF THE EMBODIMENTS

The present invention is a continuation-in part of the subject matter disclosed and claimed in U.S. Pat. No. 6,807,862, issued Oct. 26, 2004, and U.S. Ser. No. 10/942,626, filed Sep. 16, 2004. For the purposes of brevity, the subject matter of these patents is incorporated herein. These patents focused primarily on estimating the system parameters, e.g. damping, of the structure as well as trends in signal characteristics, e.g. magnitude and phase, to monitor structural decay.

The present invention is directed to real-time stability monitoring of fire or other event induced structural motion. It is important to note that the present invention is distinguished from damage detection, discussed in the prior art above. The present invention is also distinguished from collapse monitoring, as per the inventors' patent and patent application also discussed above, as discussed below. Stability monitoring measures event/fire induced vibrations throughout the changing condition in a burning structure. Stability based monitoring can be utilized in a wider range of applications, including, but not limited to, burning structures and those structures damaged by events other than fires.

Stability monitoring is based upon a Transfer Function Analysis as shown in equation (1) where:
H(s)=Output(s)/Input(s)=N(s)/D(s) (1)
Where: s is the Laplace value or complex frequency, Output is the structural vibration and Input is the excitation event/burn causing a move from normalcy. By tracking the poles (roots) of D(s) and the trend in the movement of the poles, significant information about a structure's behavior and relative stability can be ascertained.

As a structure burns, its ability to absorb impacts and return to its original position diminishes. Additionally, the time it takes a structure to recover from an “impact” is a direct indicator of its growing instability. The present invention is directed to a system and method for utilizing the declining frequency of the overall structure as an indicator of stability loss. Additionally, the present invention is also directed to a number of burn tests to identify the declining frequency that results in stability loss. The scope of the system and method is not limited to monitoring burning structures, but also includes the monitoring of weakening structures from other events.

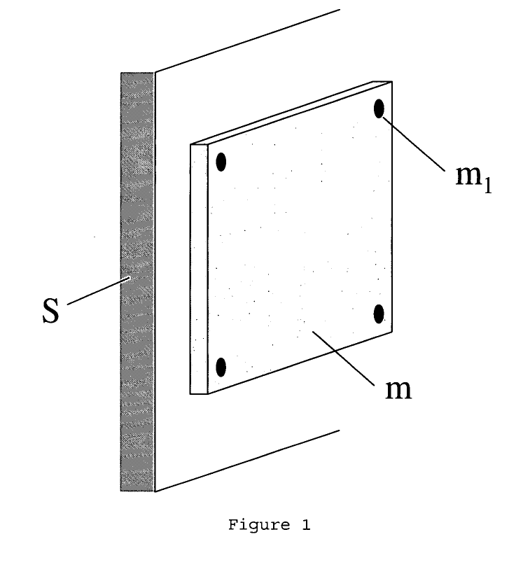

The present invention is directed to a method and system that utilizes an analog wired system and device disclosed and claimed in Applicants' U.S. Pat. No. 6,802,862. FIG. 1 shows a mounting plate (m) shaped in a plate-like configuration having pre-formed apertures (m₁). The device may be pre-attached to the mounting plate (m) or may be attached after the mounting plate (m) has been connected to the structure (S). Having pre-formed apertures (m₁) assists in limiting sensor damage during installation and allow for rapid mounting and removal of the device. In a preferred embodiment, the thickness of plate (m) is designed to have a fundamental plate resonance above 100 Hz, so as to minimize interference in the structural modes of interest. Mounting plate (m) may be protected by a ceramic layer or composed of a flame retardant plastic capable of withstanding temperatures up to 400° F. Exemplary plastic materials are those manufactured by RTP Plastics, of nylon 6/6 with 20% glass fiber and a flame retardant additive (UL94 V-0). In an alternate embodiment, mounting plate (m) can be insulated from the structure (S) utilizing thermal insulation. However, such insulation may alter signal reception.

The present invention detects vibration responses from the structure (S) to determine the stability of the structure (S) as a result of event/burn vibrations. Once mounted, the device obtains an amplified signal, then filters and removes signal noise from the signal to obtain a filtered signal that includes transient characteristics, such as vibration responses, which are then analyzed as discussed below. The present invention is directed to detecting structural instability that is characterized by growing response amplitudes that do not decay within the fixed time intervals. The data obtained from the vibration responses highlights the system's ability to sense growing transient amplitudes, the possibility of subsequent decay and the actual decay indicative of collapse. The ability of the system to provide this information allows a methodology based on tracking transient characteristics indicative of structural stability or instability.

The present invention operates with methodologies that process raw data, appearing as a combination of sinusoidal and random signals obtained through the structure (S). These signals are utilized in the present analysis method discussed below.

It is important to note that the present invention incorporates a plurality of steps that may be performed by hardware components, or may be embodied in machine-executable instructions, that in turn may be used to cause a processor to implement logic circuits programmed with the relevant instructions to execute the plurality of steps. Alternatively, the steps may be performed by a combination of hardware and software, as is understood by one of ordinary skill in the art.

The present invention may be provided as a computer program product that may include a machine readable medium having the necessary storage capacity to have stored therein instructions used to program devices such as computers or the like to perform a process according to the present invention. This machine readable medium includes, but is not limited to, Zip-drives, optical disks, floppy and hard disks, CD-ROMs, ROM, RAM, EPROM, EEPROMS, flash memory, and other mediums as is understood by one of ordinary skill in the art.

Additionally, the present invention may also be downloaded as a computer program product, wherein the program may be transferable between computers or other processing instruments via communication links and computer readable signals, as is understood by one of ordinary skill in the art.

Frequency Based Indicator Analysis Techniques

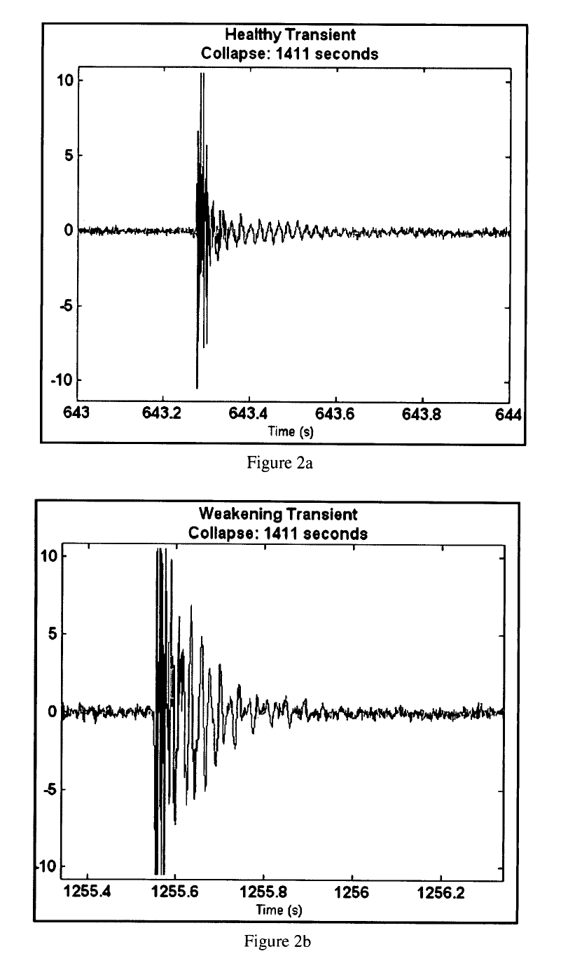

During various burn tests in accordance with the present invention, it was determined that the transient response of a structure (S) changed as it lost stability over time. FIG. 2a shows a healthy transient response of a burning structure. FIG. 2b shows a change from the healthy transient response shown in FIG. 2a as depicted by an increased duration of time required to dissipate the transient response of a burning structure. As can be seen from FIG. 2b, the decay of a weakening structure is evidenced by a longer decay time of an event near collapse. This indicates that the structure's ability to damp out vibrations decreases toward instability. The present invention is directed to tracking these damp out vibrations as a structure approaches instability.

In accordance with the present invention, a structure is described by the second order MDOF equations of motion:
M(x″)+C(x′)+K(x)=f(t) (2)
where M, C and K are the mass, damping, and stiffness matrices and x and f are the displacement and forcing vectors, x′ is the velocity vector and x″ is the acceleration vector, respectively.
A transformation is applied to this set of equations by letting:
x=Aq (3)
where A is a transformation matrix comprised of the eigenvectors of the system and q is the corresponding generalized displacement vector, q′ is the generalized velocity vector and q″ is the generalized acceleration vector.
The equations of motion become
A^{T}MA(q″)+A^{T}CA(q′)+A^{T}KAq=A^{T}f(t) (4)

$$Where {A}^{T} MA = [ I ] , \\ {A}^{T} CA = [ \begin{matrix}⋰ & ⋯ & 0 \\ ⋮ & 2 {ξ}_{i} {ω}_{i} & ⋮ \\ 0 & ⋯ & ⋰\end{matrix} ] and {A}^{T} KA = [ \begin{matrix}⋰ & ⋯ & 0 \\ ⋮ & {ω}_{i}^{2} & ⋮ \\ 0 & ⋯ & ⋰\end{matrix} ] . \qquad Equation ( 5 )$$

As a structure weakens, due to fire or any general destructive loading, it loses strength. As shown in equation (4) above, A^{T}KA is the generalized stiffness of the structure or, equally, the strength of the structure. Thus, as the structure weakens and loses strength, the matrix of natural frequencies declines correspondingly. Since the lumped model assumed above is but an approximation of the continuous, nonlinear, and time dependent nature of the system being examined, complete adherence to this simplified theory of declining frequency cannot be expected, and some frequencies remain constant in the actual data. However, the underlying principle of declining frequency as it relates to damage results in at least some of the frequencies being adversely affected by structural damage. To take advantage of this general relationship between frequency and strength, the present invention is directed to methods for tracking dominant frequencies during the life of a burn/event. These include a bank of band pass filters to obtain a time-frequency distribution frequency trend detection using the Short-Time Fourier time-frequency distribution and acoustic indicators, dominant frequency tracking using the wavelet transform, average instantaneous frequency tracking of separated modes using the Empirical Mode Decomposition, and instantaneous frequency tracking of the complete signal.
Spectrogram Using a Bank of Band Pass Filters

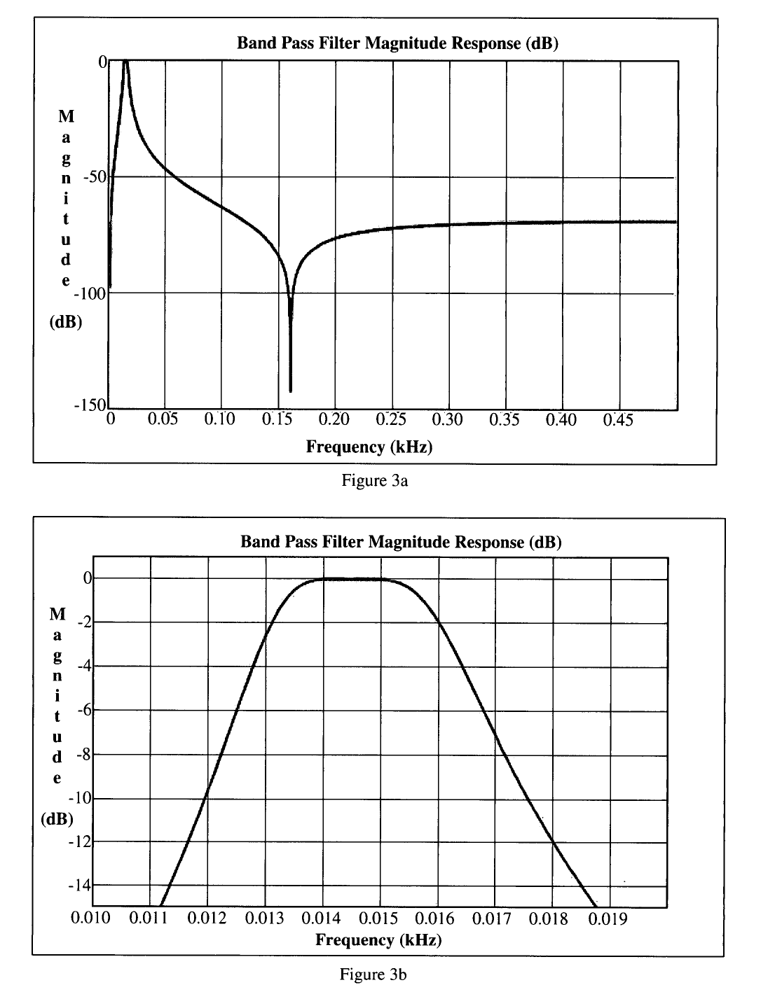

In accordance with the present invention, the most basic technique for extracting the frequency trends in an event/burn is to pass a signal through a large bank of band pass filters. These narrow-band filters separate the power in each frequency range over time. This information can be displayed by calculating the mean squared value (MSV) for each filtered segment and plotting versus frequency, as discussed below. As shown in FIGS. 3a and 3b, after investigation of various filter qualities and effects, a second order elliptical band pass filter was chosen due to its minimal amplification or attenuation of the band. This allows for bandwidths as narrow as 0.5 Hz from which to extract the MSV. This technique is similar to the Short-Time Fourier, Wavelet, Wigner, Choi-Williams and other time frequency distributions but has the advantage of being possible to implement as an analog filter bank.

Spectrogram Trend Identification and Acoustic Indicators

Although acoustic measurements have since been disregarded in favor of mechanical vibration measurements, sound is still useful for providing information to firefighters. The resulting data can be time and frequency shifted to provide an audible signal relevant to the trend in structural stability.

### Example 1

Adobe Audition, a commercially available audio editing software package, was used to de-noise the test burn data to produce cleaner spectrograms and more prominent trends in frequency. This tool is traditionally used to remove the ambient noise recorded by a microphone. The user selects a portion of the audio track containing only undesired noise. Adobe Audition then creates a Noise Reduction Profile from the selected region, which records the spectral power of the noise in this region using the FFT. The entire audio track is then analyzed spectrally in blocks of 12,000 samples and the noisy frequencies (according to the created profile) are attenuated. Noise reduction always results in a decrease in RMS since frequency bands are only attenuated and not amplified.

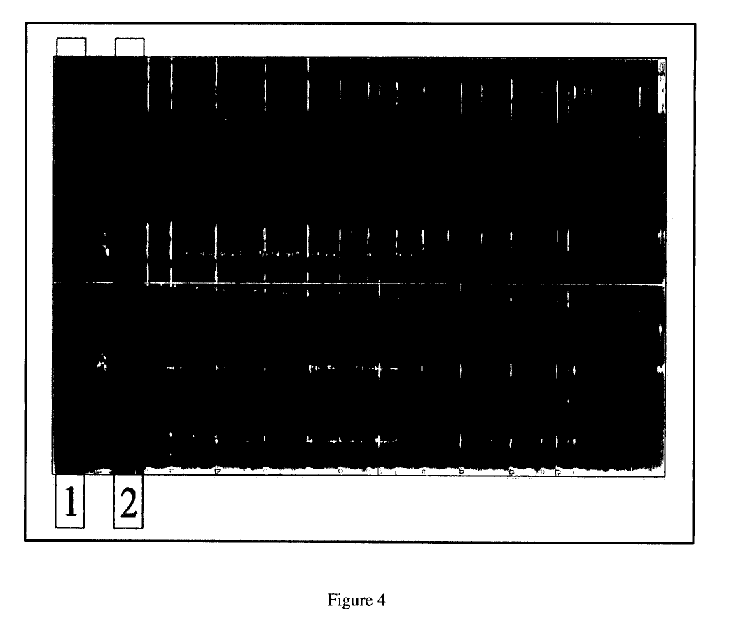

Two different methods of applying the Noise Reduction Tool have been developed to emphasize meaningful frequency content. The first method increases the contrast between structural vibrations and ambient noise. This application is similar to the traditional use of this tool in the recording industry. The first noise profile is created from a section of the data when the structure is healthy and before flame excitation. This profile should account for ambient acoustic input, the 60 Hz cycle and its harmonics from nearby generators or fire trucks, and the accelerometer's noise floor. The second method highlights changes in the structural vibrations as the system is damaged. Since the power in different frequency bands shifts with damage, the spectral fingerprint of the structure will change over the life of the burn. By characterizing the healthy structure and then subtracting this spectral fingerprint from the damaged structure's spectral content, only shifts in frequency power representing damage are present in the final signal. FIG. 4 shows locations of representative noise profiles on a frame burn. The first profile region, indicated by “1”, attenuates ambient noise and generator harmonics. The second profile region, indicated by “2” is used to remove resonances of the healthy structure; leaving only shifts in power as the structure is damaged.

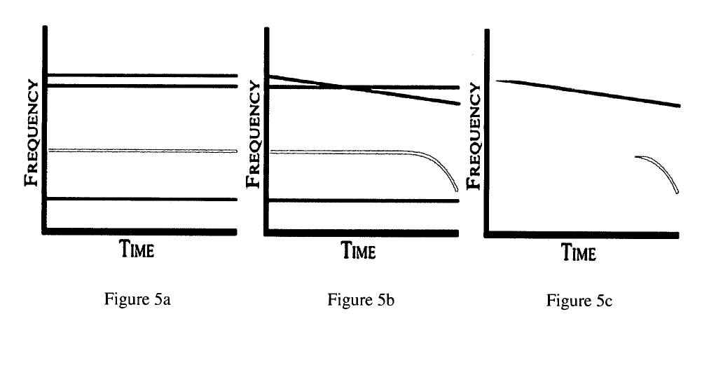

In the frame burns, the noise profile is selected from the brief time after the torches are ignited, but before the structure is significantly damaged. Assuming that the fire excitation is random white noise and has constant power over time, the system should receive a time-invariant excitation. Selecting a sufficiently large profile block accounts for the randomness of the fire noise and the resulting de-noised signal contains minimal artifacts from the torches. FIG. 5a shows the constant value resonances observed from a healthy structure with constant excitation. FIG. 5b shows frequency shifts as the structure is damaged over time. FIG. 5c shows the result of removing the noise profile from the undamaged, excited structure. In the resulting signal, all constant resonances have been attenuated and the downward trends have been highlighted.

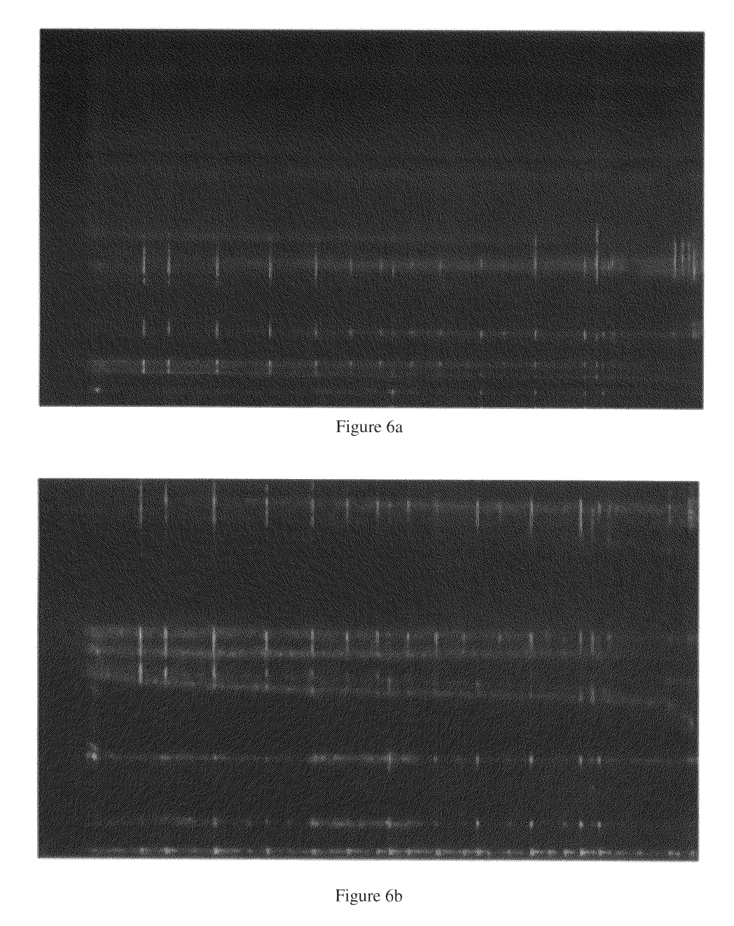

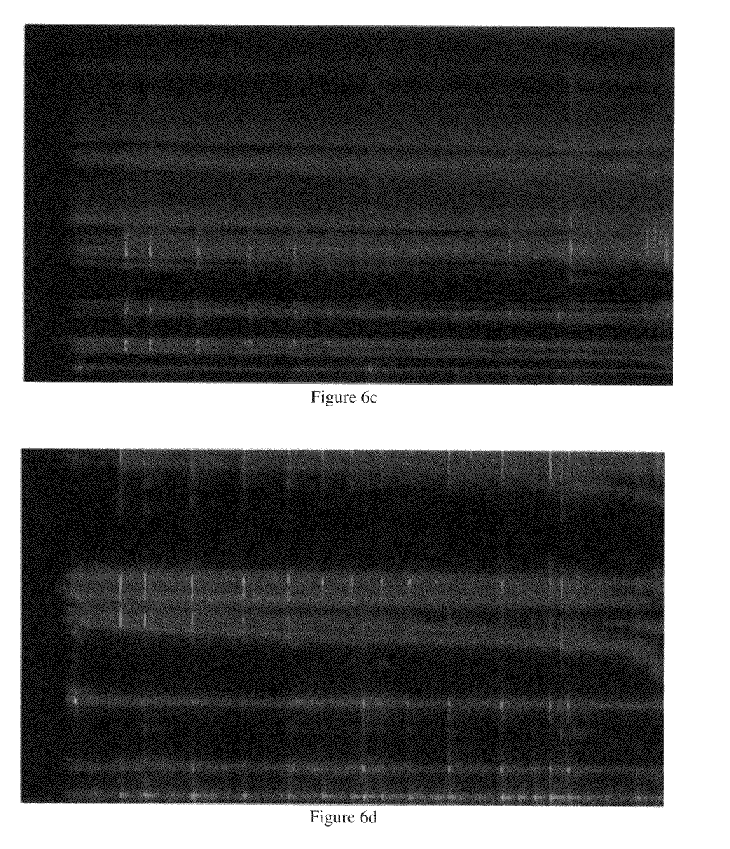

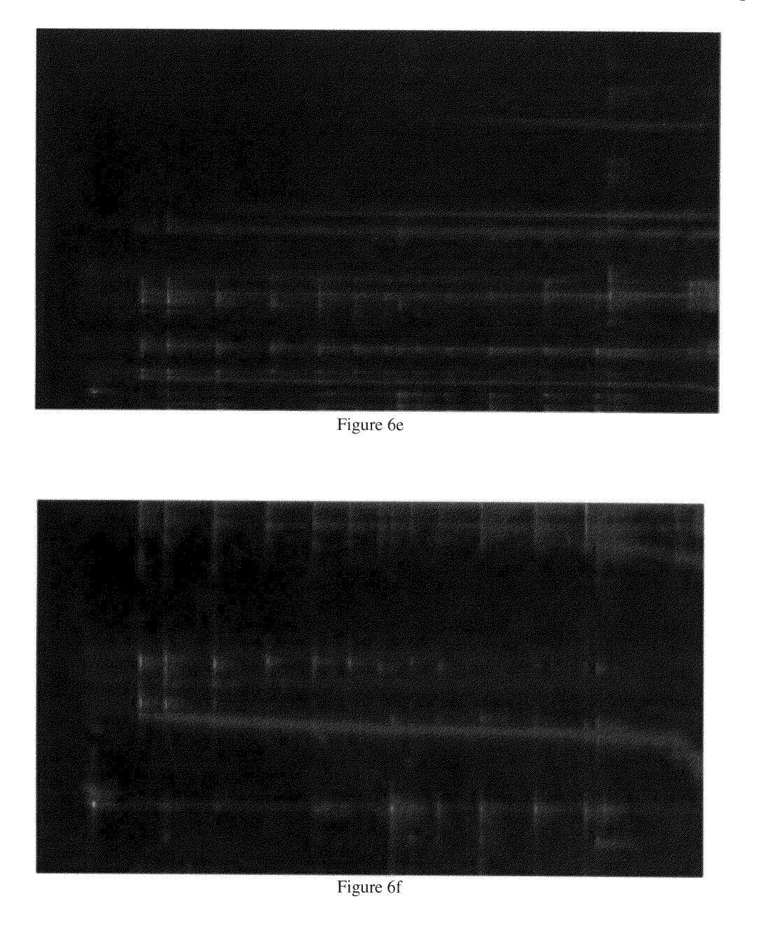

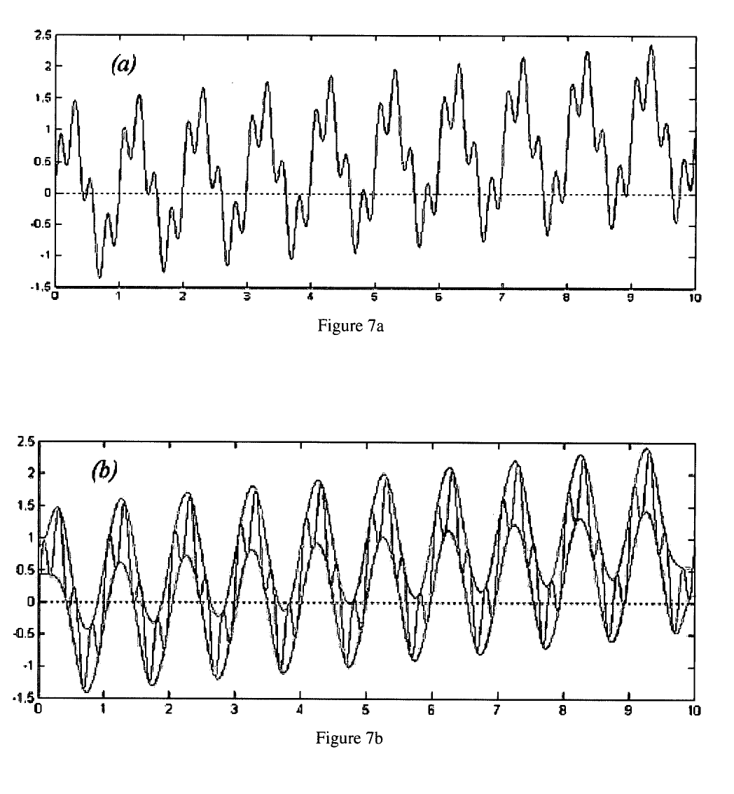

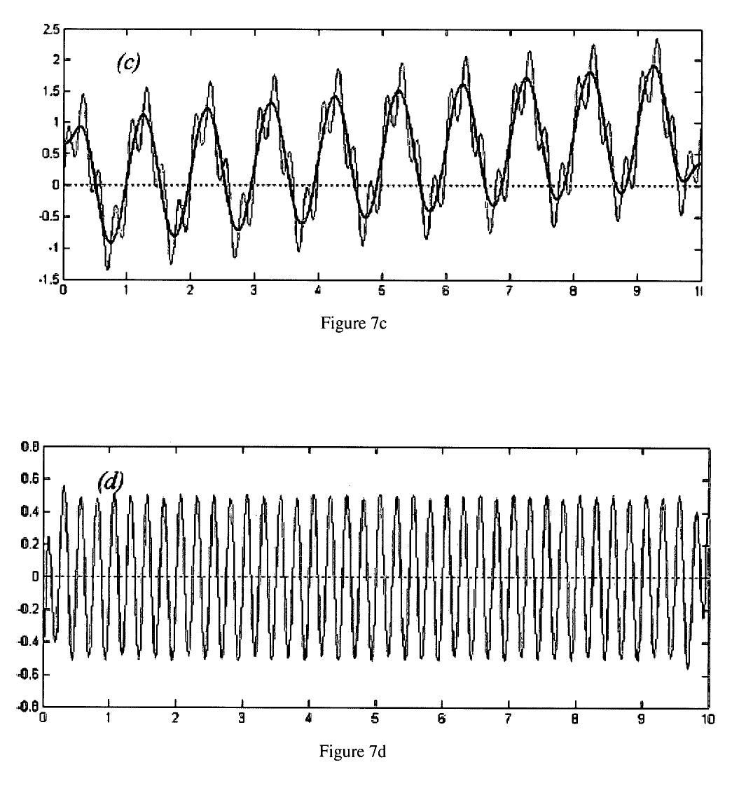

The examples of de-noising shown in FIGS. 6a through 6f show the difference between the two methods of noise reduction discussed above. FIG. 6a shows the unprocessed spectral content of a frame burn showing frequencies from 0 to 2500 Hz. FIG. 6b shows the unprocessed spectral content of the same frame burn, but showing only frequencies up to 430 Hz. FIG. 6c shows frequencies from 0 to 2500 Hz after the ambient noise is reduced using the first profile region attenuating ambient noise and generator harmonics of FIG. 7. FIG. 6d shows the same region as shown in FIG. 6b after the first noise reduction profile attenuating ambient noise and generator harmonics, as shown in FIG. 7, is utilized. FIG. 6e shows frequencies from 0 to 2500 Hz after the health resonance is attenuated where the second noise profile is removed from the undamaged, excited structure. FIG. 6f shows the same region as FIG. 6d, but the healthy resonances are reduced. Since the second noise profile contains more power, it attenuates more frequencies by a larger amount. The single downward trend in frequency is more apparent in FIG. 6d than in FIG. 6f, since applying the second noise profile removes the constant healthy structural resonances. An ideal impact includes all frequencies, and the observed transients in the signal are therefore represented over a broad spectral range. Since most of the power in the second noise profile occurs around discrete frequency bands, the noise attenuation is also focused around these bands. This results in large transients producing spectral content at non-resonating frequencies and is an artifact of the Fourier Transform. If the final signal is to be similar to a siren, it must be free of major transients. Although the noise reduction tool will not attenuate transients due to their broadband nature, manipulating the time domain signal can minimize transients. With the signal containing only the damaged resonances, it is possible to create a siren that could alert firefighters to the progression of damage. This siren could consist of the blocks of the signal as the frequencies decrease, much like a descending musical scale. Another siren would simply speed up the time, which would create a sound similar to a slide whistle. These sirens would communicate the health of the structure to firefighters without requiring them to look at a screen or analyze graphs. If trends can be automatically identified and converted into a siren, this could provide a powerful link between the developed algorithms and firefighters.

Dominant Frequency Tracking Using the Wavelet Transform:

The Wavelet transform is typically used to obtain a time-frequency representation of a time varying signal. The wavelet
transform of a signal, x(t), is the convolution of the signal with a parent wavelet, ψ*(t), according to equation (6):

$$W ( a , t ) = \frac{1}{\sqrt{a}} {\int }_{- ∞}^{∞} x ( τ ) {ψ}^{*} ( \frac{t - τ}{a} ) ⅆ τ \qquad ( 6 )$$

where a, τ are scaling and translation factors, respectively. The resulting coefficients allow time and frequency localization such that changes in frequencies can be tracked over time using peak tracking algorithms. This analysis is described in further detail in Ser. No. 10/942,626 and incorporated herein. A searching scheme is utilized to sort a user determined number of dominant frequencies as they change over time.
Modal Frequency Tracking Using the Empirical Mode Decomposition

The Empirical Mode Decomposition indicator is based on the underlying principles of the recently developed Hilbert-Huang transform. The transform is a completely a posteriori method of signal processing to address limitations in current signal processing with regard to nonlinear and time-varying systems. The basis of the transform lies in the method of Empirical Mode Decomposition (EMD) which separates a complex multi-component time signature into a manageable finite number of mono-component intrinsic mode functions (IMFs). The Instantaneous Frequency derived from the Hilbert Transform can be defined for these monocomponent IMFs and recombined in a time-frequency plot that reveals the underlying time-dependent frequency characteristics of the signal.

The method of Empirical Mode Decomposition (EMD) is as defined in equation (7):
x(t)=sin 2πt+0.5 sin 8πt+t/10 (7)
where x(t) is the function of the displacement over time.
This ‘sifting’ process is summarized in FIGS. 7a through 7d. FIG. 7a shows the multi-component signal with riding wave and non-constant offset. The zero line is shown as a reference. In FIG. 7b, the local extrema are fit with cubic splines through maxima and minima, creating a signal envelope. The local maxima and minima of the signal are each fit by a cubic spline resulting in a spline envelope of the signal, as shown in FIG. 7c. The mean of the spline envelope is defined and retains the lower frequency content of the signal. The mean of this envelope is subtracted from the signal and the resulting mono-component function becomes the intrinsic mode function, as shown in FIG. 7d. The spline end effects are seen at the ends of the IMF. In practice, the ‘sifting’ process must be repeated to produce a well-conditioned IMF that exhibits a locally symmetric zero-mean. Each IMF should contain progressively longer local time scales such that the first IMF contains the highest frequency component of the signal and the final IMF contains the underlying trend of the data (and is, subsequently, not a true IMF). The complete decomposition can be added to the residual trend to obtain the original signal since the EMD process is defined by subtracting IMF components from the original signal.

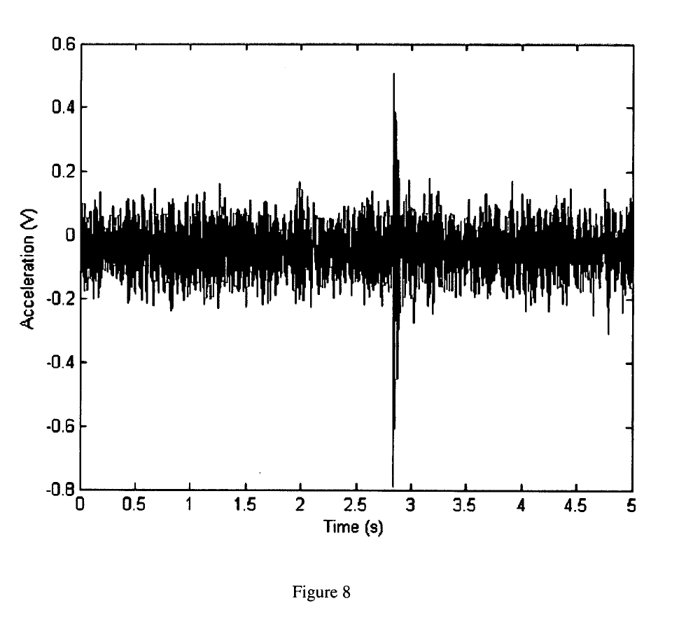

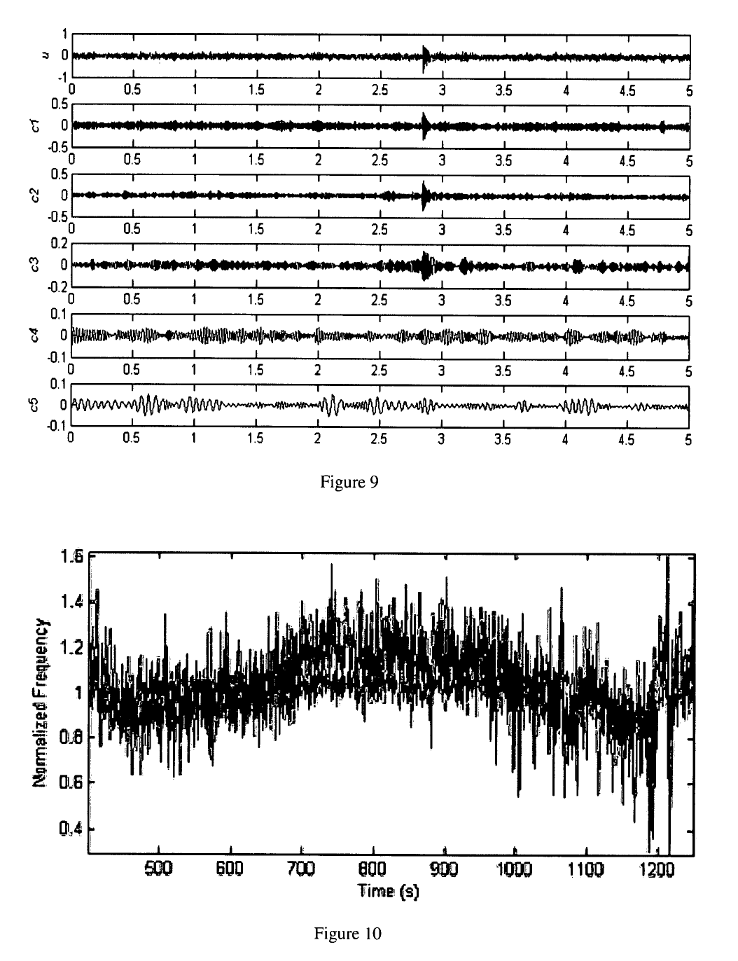

The stability indicator developed over the past funding period is based on tracking the instantaneous frequency of the decomposed intrinsic mode functions. This process is illustrated in FIG. 8, which shows a structural acceleration response of a burning test frame. Utilizing the 5 second vibration sample from FIG. 8, the EMD process results in a total of 14 IMFs, of which the first five are shown in FIG. 9. Assuming that the decreasing frequency trend corresponding to a loss of stability is contained in the higher frequency modes, the computation time required to perform the decomposition decreases substantially as only the first few IMFs need to be sifted out of the signal to track the frequency trend. The phenomenon of mode-mixing due to the intermittent occurrence of a frequency can be seen in the fifth IMF of FIG. 9. This creates IMFs containing information from multiple distinct modes that significantly decreases the effectiveness of an indicator based on the average instantaneous frequency of a single IMF. The present invention is directed to utilizing the intermittency criterion and isolating single component modes utilizing the Hilbert-Huang transform and implementing a zero-counting algorithm.

The stability indicator takes finite time samples of the acceleration response and computes the aver age of the instantaneous frequency of the first five IMFs over the sample period. The length of sampling period is an important constraint in determining the accuracy of the average instantaneous frequency, as a small number of cycles can be influenced by the end effects of the Hilbert Transform. However, since the first five IMFs have frequencies substantially greater than the sampling frequency, the detrimental end effects are offset by the large number of cycles per sampling period, and the average instantaneous frequency estimate is relatively accurate. In the case of this indicator, the average instantaneous frequency is estimated using only the center portion of the IMF sample with the regions most likely to contain end effects removed. Current research has focused on the possibility of windowing the IMFs to reduce the end effects due to the spline fitting and the Hilbert Transform. The “full” average instantaneous frequency tracking algorithm is demonstrated in FIG. 10 based on the complete burn data from the record in FIG. 8. This algorithm is referred to as “full” because, while the IMFs are computed for 1 second samples of the complete record, the samples are taken 1 second apart such that the entire record is analyzed.

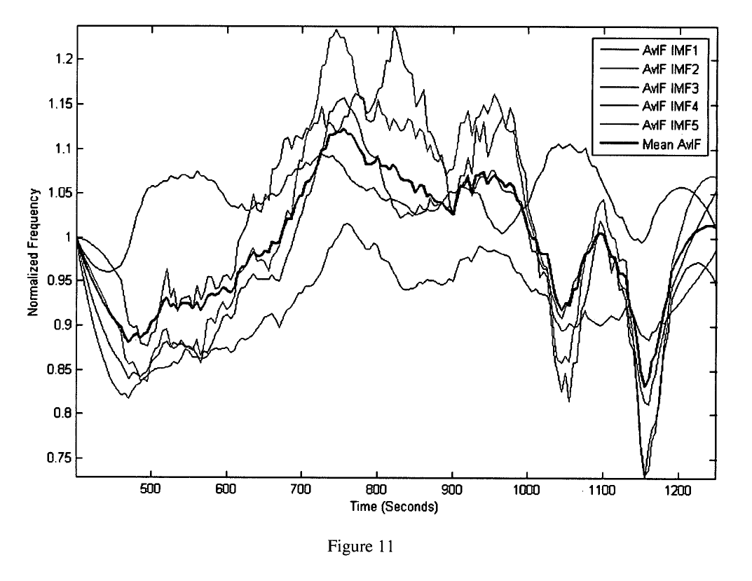

FIG. 10 shows a rising trend corresponding to a shift in power over the frequency bands of the structure as well as a decrease in frequency leading up to collapse, which indicates deterioration and irreversible loss of stability in the structure. For reference, the first collapse event of the frame occurs at 982 seconds and the final collapse occurs at 1192 seconds. The peak in the average frequency trend can be interpreted as the point where the deterioration of the structure becomes dominant and the shifting power has stabilized. The amount of computation time can be decreased further while retaining the same overall trend by using a “partial” average instantaneous frequency tracking algorithm which uses discrete sample blocks spaced over a larger time interval. The algorithm used to produce the “partial” result, shown in FIG. 11, uses half-second blocks spaced over five second intervals, and effectively computes the average instantaneous frequency from only one-tenth of the entire time record. The result is smoothed using 25-point Savitzky-Golay smoothing, and the shape of the curve matches the result shown in FIG. 10. The average instantaneous frequency obtained from the “full” algorithm can be similarly smoothed to reveal a clearer picture of the overall frequency trend. Note that the first IMF does not contain a trend similar to the other IMFs. Due to the large amount of acoustic noise from the torches used to conduct the frame burn, this vibration signature (which oscillates between 250 Hz and 300 Hz) may be acoustic. A number of other vibration records from other burn tests exhibit similar frequency trends leading to collapse that typically involve a single peak in the frequency trend midway through the burn followed by a downward trend toward collapse.

Dominant Frequency Tracking Using the Instantaneous Frequency

The instantaneous frequency of a multi-component signal, while previously shown to be mathematically unacceptable, provides information on structural stability. The dominant instantaneous frequency indicator has a similar theoretical basis as that of the Empirical Mode Decomposition indicator since it considers the instantaneous frequency of the analytic signal Z(t) obtained through the Hilbert Transform. Instead of decomposing the multi-component signal into a number of mono-component residuals, the dominant instantaneous frequency indicator takes the instantaneous frequency of the entire signal. The resulting instantaneous frequency curve is a mathematically meaningless representation of the multiple frequency modes present in the original signal, but a sufficiently dominant frequency mode can be extracted either by linearly fitting the instantaneous phase angle or low-pass filtering the instantaneous frequency curve. In accordance with the present invention, the current implementation of the dominant instantaneous frequency indicator calculates the instantaneous frequency curve for a 30 second data set every 5 seconds (e.g. 25 seconds of overlap between neighboring sets) and low-pass filters this curve to obtain an estimate of the frequency of the dominant mode. Results indicate that as the system weakens the dominant instantaneous frequency values decay and never return to the values of the healthy structure.

Applications to Burning Structures

The declining frequency analysis has been applied to several simple frame structure burns and two larger frame school building burns. Examples of results of burns for these structures are given below:

### Example 2

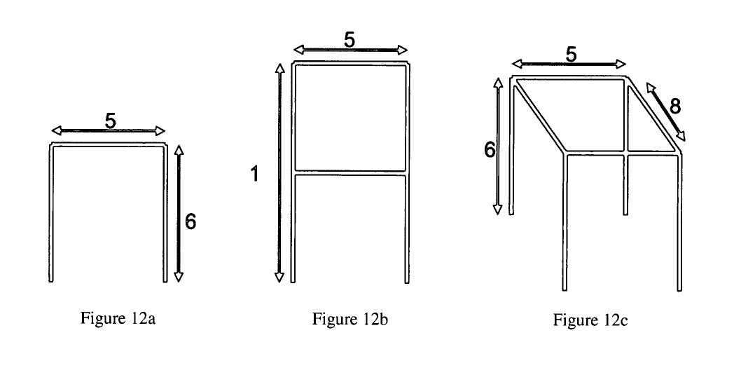

A number of simple frames were constructed for the purpose of evaluating the performance of stability indicators in the field and to collect meaningful failure events. Eleven simple frames were built at the Los Angeles County Fire Training Facility in Pomona, Calif., with burn tests conducted during June and July of 2006. Of the eleven total frames, the first five frames consisted of two vertical columns and a single cross beam (header), two were two-story frames, and the final four burns were individual collapse events from a single-story space frame. All the frame types are shown in FIGS. 12a through 12c. Each frame was designed to produce a single, dominant collapse event involving the fracture of the cross beam, without major damage done to the vertical columns. To induce this collapse event, the center of each cross beam was pre-loaded at center span with 350 lbs. Fire was applied through the use of a flame impingement device (not shown).

### Example 3

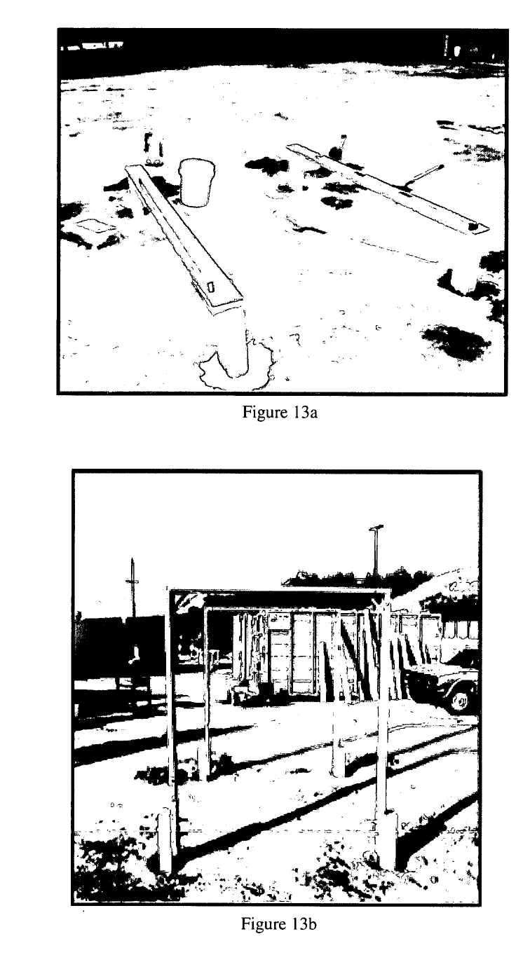

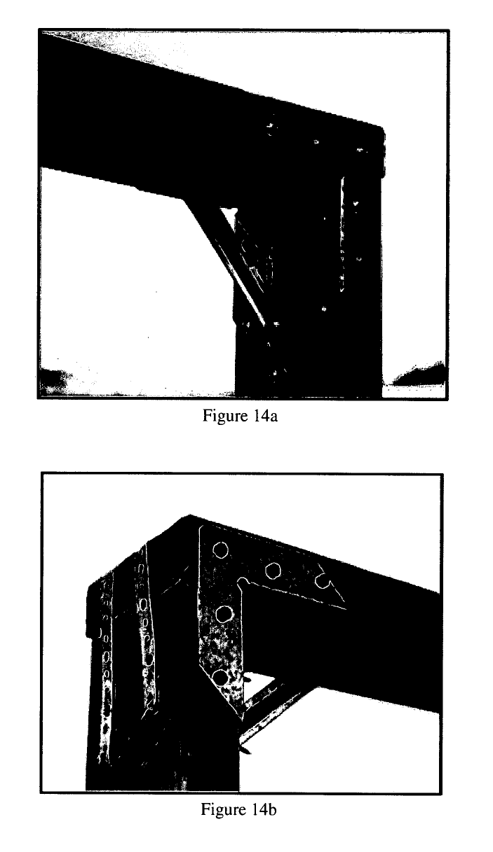

To obtain repeatable results, the construction of the frames had to be as close to identical as possible. Two sets of frames were able to be built next to each other, as seen in FIG. 13a. Posts were sunk into holes two feet deep and reinforced with poured concrete to stabilize the base of the frame. The posts were carefully measured and leveled as they were installed, as shown in FIG. 13b. Failure of the beams was projected to occur at a single mid-span collapse of the beam where the load was applied. As a result, the connections between the horizontal beam and support columns were designed to prevent a failure scenario in which the joint connection fails due to tensile stress as the cross beam weakens. Each of the joints in the frames had bookshelf supports, corner braces and hurricane strapping, shown in FIGS. 14a and 14b, in order to transmit vibrations to the support columns and to encourage failure in the cross beam rather than in the joint. Accelerometers, as taught in U.S. Pat. No. 6,807,862 were installed on the columns of the structure.

### Example 4

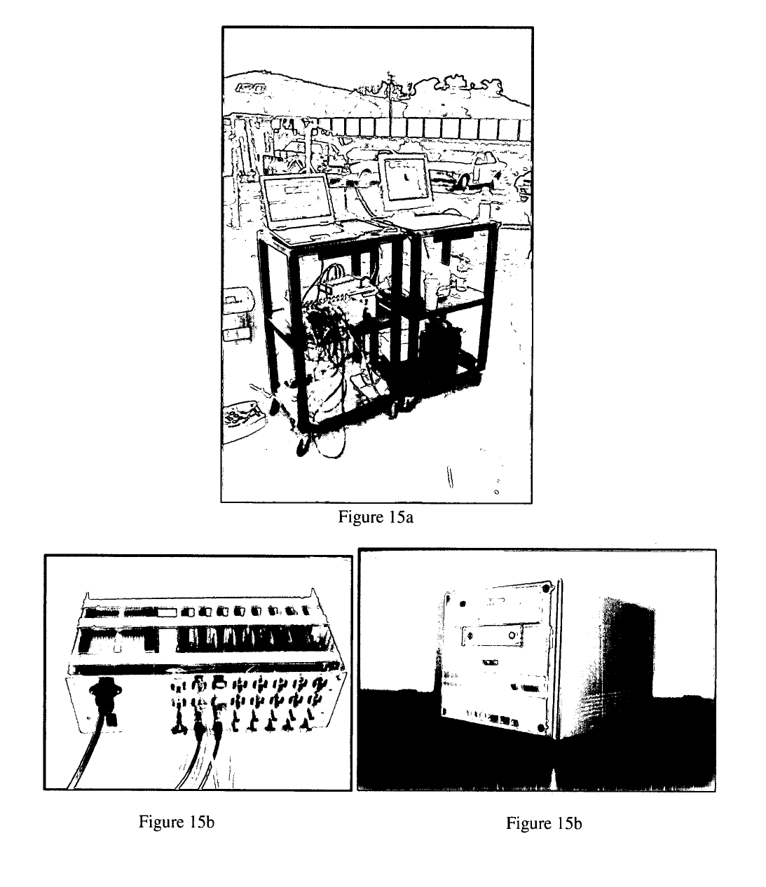

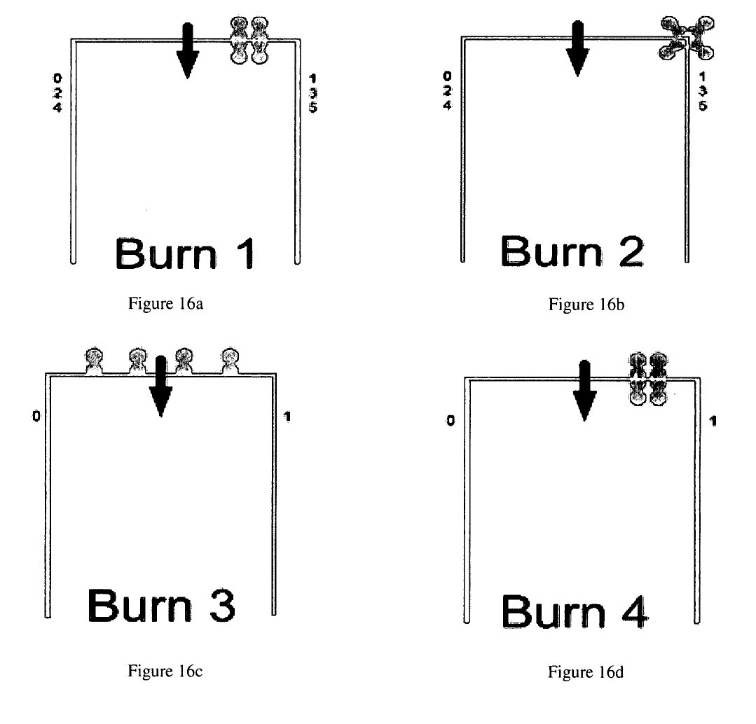

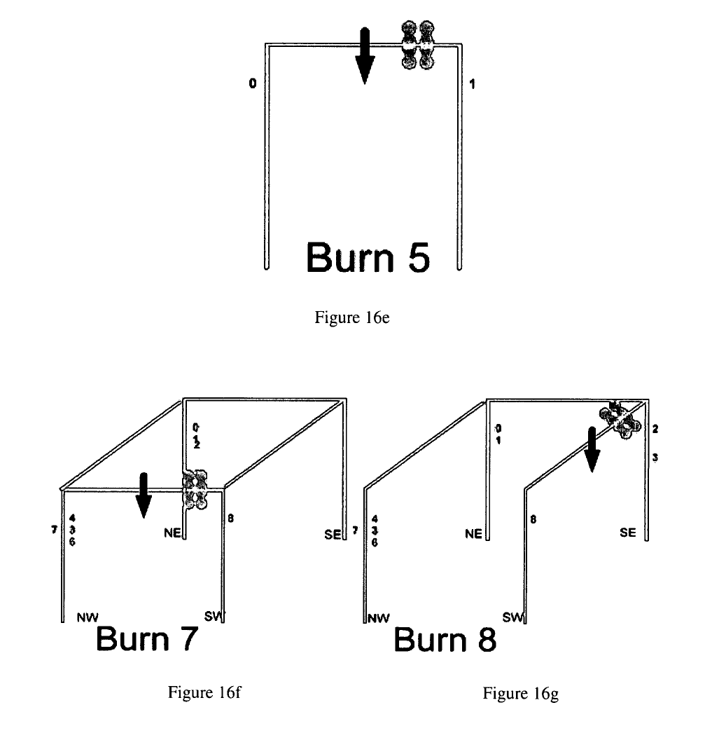

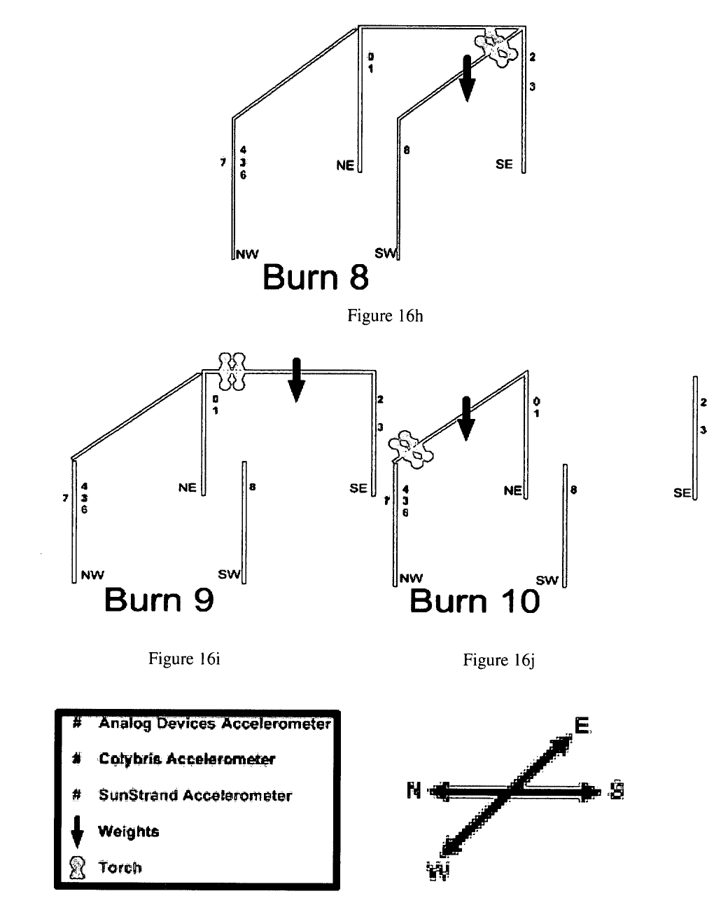

Accelerometers were mounted onto the support columns and cables transferred the data to a custom filter box as shown in FIG. 15a. The accelerometers were filtered at either 150 Hz or 400 Hz depending on the test, and they were gained at 1 or 10 depending on individual sensor sensitivities. Some burns included the analog sensors along with the older Colibrys and Sundstrand sensors for calibration. Data Acquisition was done with two separate computers in order to protect against system failure. The data was split from the filter box to an onsite data acquisition system at 1000 samples per second, shown FIG. 15b. Additionally, data was also sent to an archive system taking data at 5000 samples per second, as shown in FIG. 15c. The data acquisition systems are as taught in U.S. Pat. No. 6,807,862. FIG. 16a through 16j shows the location of the accelerometers for on each burn, and which types were used.

### Example 5

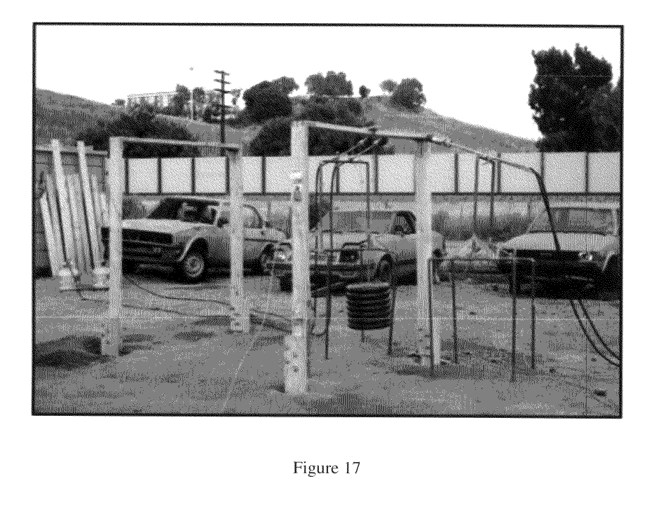

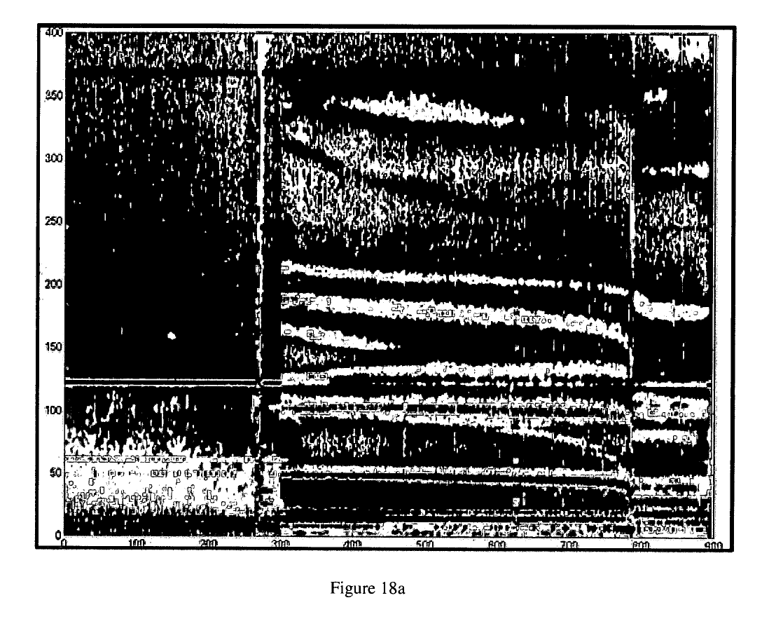

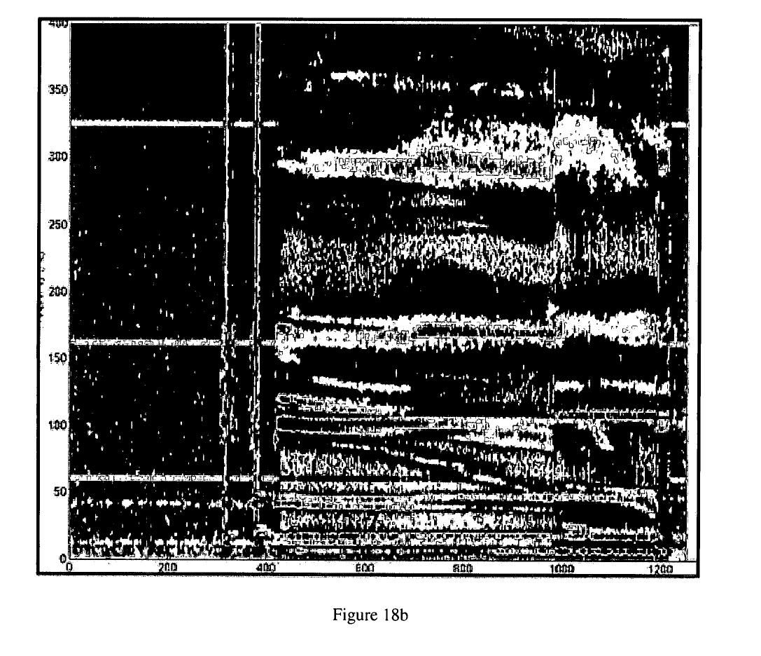

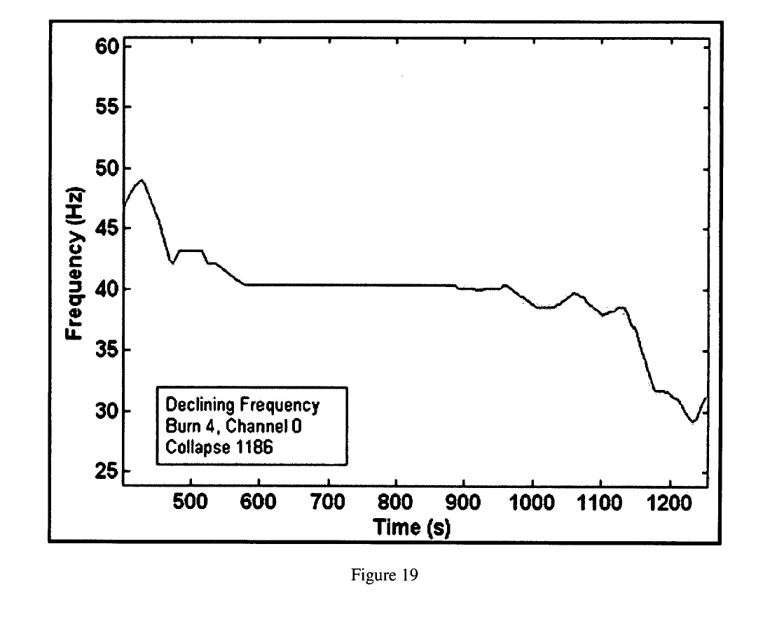

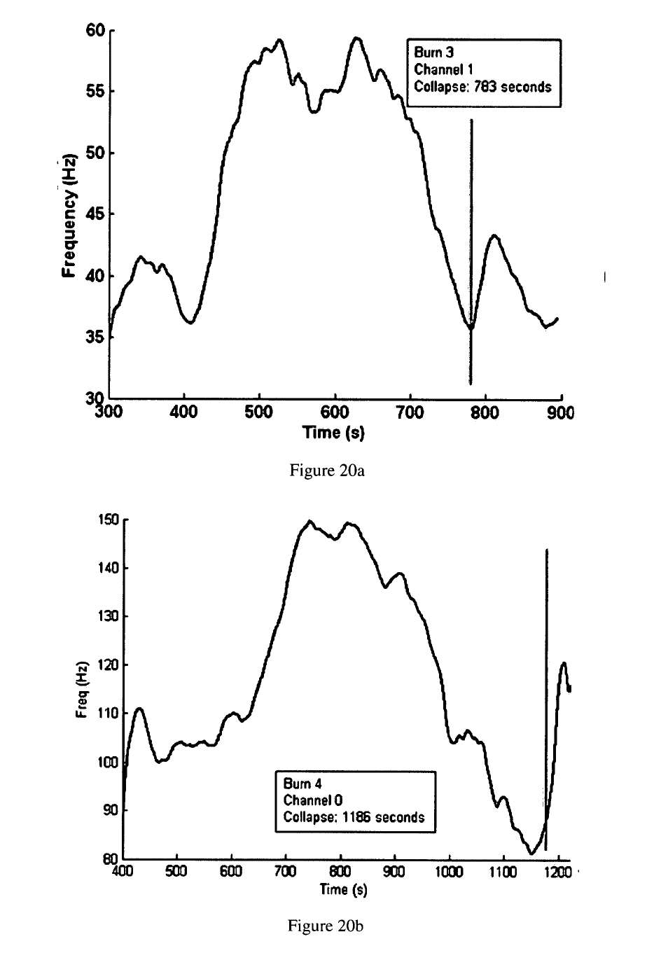

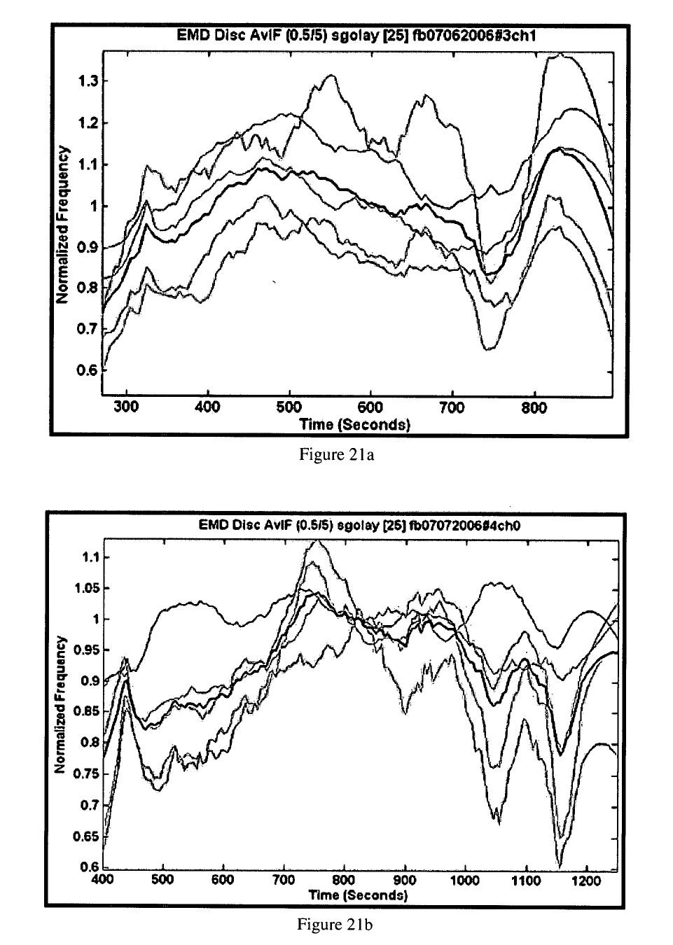

The purpose of a simple frame burn is to induce a single collapse event. The torch system provides pinpoint flame impingement at one section of the beam, which weakens over time. The beam is loaded in order to decrease collapse time and induce collapse. A typical burn setup is shown in FIG. 17. Results from the simple frame burns were examined. As shown in FIGS. 18a and 18b, time-frequency distributions acquired using the band pass filtering technique show decreasing frequency trends. The first frame shown in FIG. 18a illustrates very specific decreases for a number of the modes. Results are similar for the second frame shown in FIG. 18b. The span of data in the beginning of the data set shows the frame before ignition. The discontinuity in the time frequency distribution near the end of the set is indicative of a major collapse event. The frame shown in FIG. 18b includes two major collapse events due to initial buckling and final separation of the cross beam. The time-domain signals corresponding to these distributions are further examined using the frequency-based indicators previously introduced. Using the Wavelet Transform approach, a single frequency component is monitored throughout the burn of the second frame. As shown in FIG. 19, the frequency component remains constant at 40 Hz for the middle span of the burn. However, by collapse at 1186 seconds, the frequency component drops to 30 Hz. The Instantaneous Frequency approach was applied to the simple frame data as well. While there were no constant frequency components observed mid-burn like the Wavelet Transform, FIGS. 20a and 20b show that collapse does occur after a decrease in frequencies. Multiple frequency components are tracked and displayed by applying the EMD approach. The normalized frequencies, as shown in FIG. 21a, corresponding to the frame shown in FIG. 20a and FIG. 21b, corresponding to the frame shown in FIG. 20b, indicate decreasing frequency trends. Collapse occurs in both frames after an increase and subsequent decrease in frequencies. This may be partially due to a shift in power between the frequency bands being tracked. The initial collapse event in near 1000 seconds, as shown in FIG. 21b, is captured by this indicator, in addition to the final event.

### Example 6

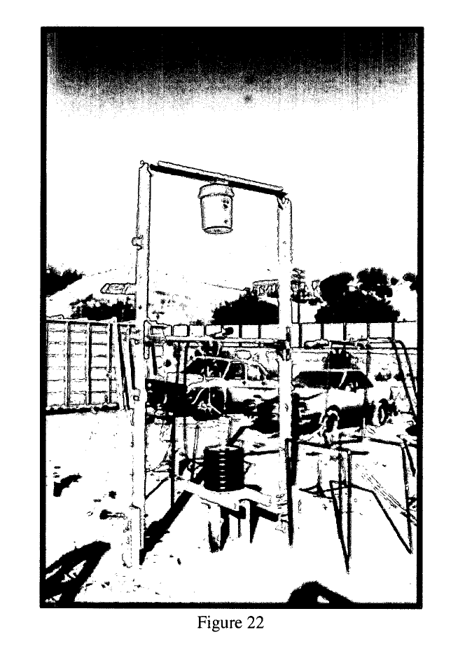

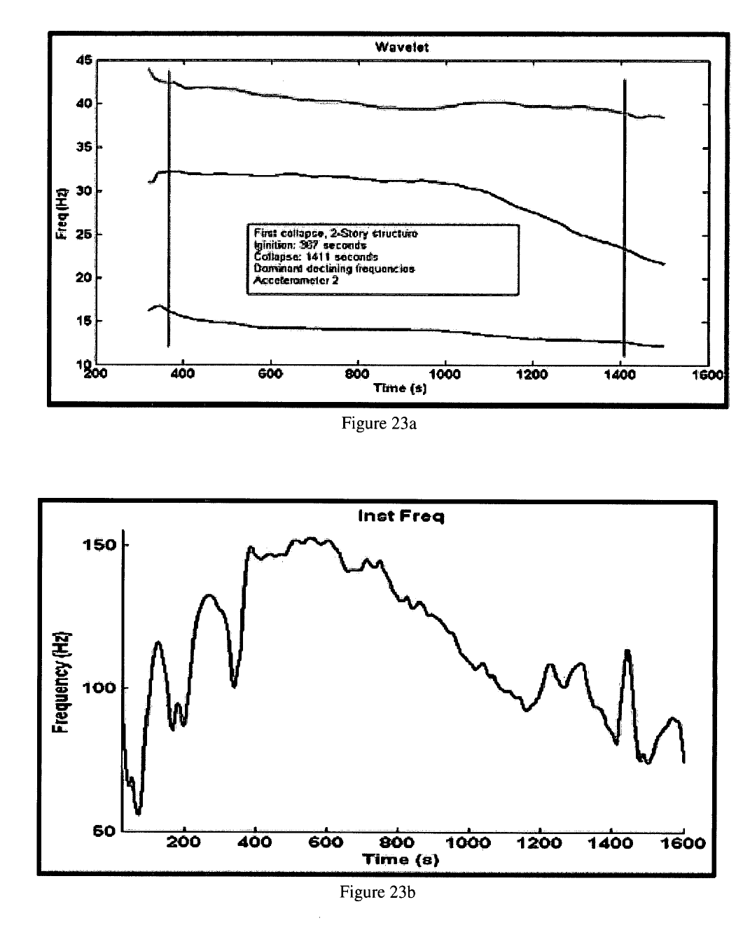

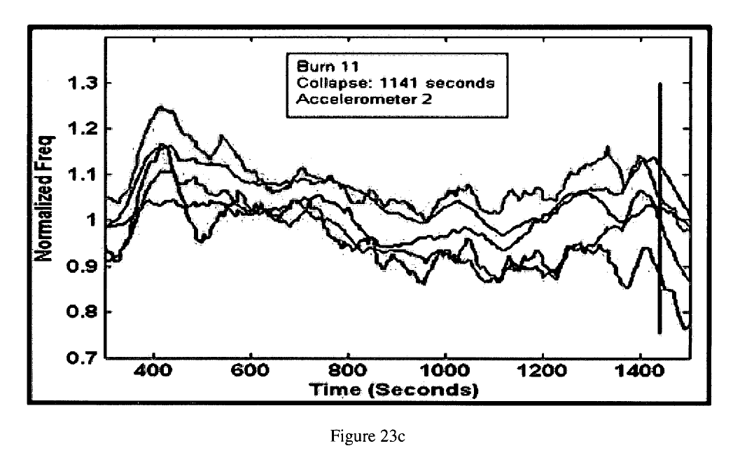

The analysis technique was applied to other frame burns. A two-story frame, as shown in FIG. 22, yielded results shown in FIGS. 23a, 23b and 23c. The collapse observed and noted was from the collapse of the main weights, which were fixed to the center of the first-story beam. Decreasing frequencies are observed in all analysis methods. FIG. 23a shows three frequency components using the wavelet approach. FIG. 23b shows a general decreasing trend using the Instantaneous Frequency approach. FIG. 23c shows a slight decrease in multiple frequency components using the EMD approach.

### Example 7

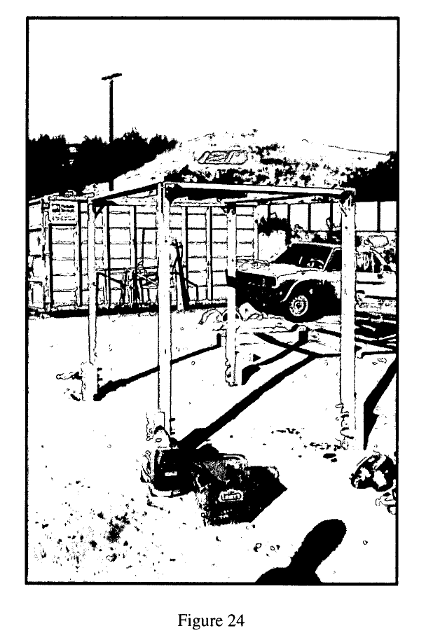

The single-story space frame, shown in FIG. 24, was burned in four separate burns, and acted as a series of coupled simple planar frames. The purpose of this test was to determine the spatial response throughout the structure in an effort to provide damage localization information. Results were obtained using the previously mentioned analysis techniques. Analysis and evaluation is still in progress to compare the four burns from the space frame with the other frame burns. Results are also being analyzed to find discover optimal relationships between the accelerometer placement and flame concentration site.

What is claimed is:

1. A method for determining stability of a structure comprising:
utilizing a real-time system structural stability monitoring system based upon Frequency Based Indicator Analysis said Frequency Based Indicator Analysis having at least one of a Wavelet Transform Analysis, an Empirical Mode Decomposition Analysis and an Instantaneous Frequency Analysis.

2. A method as recited in claim 1 and further comprising the steps of:
(a) utilizing a thermally protected mounting plate and attaching a stability monitoring device of said system to said structure;
(b) obtaining an amplified signal from said system;
(c) filtering and removing signal noise from said signal; and
(d) obtaining a filtered signal.

3. A method as recited in claim 2, wherein said filtering step further comprises locating frequencies to be utilized by said Analysis.

4. A method as recited in claim 3, wherein said Frequency Based Indicator Analysis further comprises determining changes in transient responses of said structure and lost stability of said structure over time.

5. A method as recited in claim 4, wherein said Frequency Based Indicator Analysis further comprises obtaining dominant frequency tracking utilizing said Wavelet Transform Analysis, obtaining average instantaneous frequency tracking of separated modes utilizing said Empirical Mode Decomposition and said Instantaneous Frequency Tracking.

6. A method as recited in claim 5 and further comprising verifying said Frequency Based Indicator Analysis by passing a signal through a bank of band pass filters.

7. A method as recited in claim 6, and further comprising displaying stability information.

8. A method as recited in claim 7, wherein said displaying of said information utilizes acoustic indicators.

9. A method as recited in claim 8, wherein said acoustic indicators utilizes a first and second noise reduction tool.

10. A method as recited in claim 9, further comprising the steps of:
(a) increasing contrast between structural vibrations and ambient noise as said first tool;
(b) highlighting changes in said structural vibrations as said structure is damaged as said second tool;
(c) creating a spectral fingerprint of said structure that changes over time;
(d) utilizing characteristics of said structure when it is healthy, subtracting said spectral fingerprint from said damaged structure spectral content;
(e) obtaining shifts in frequency power representing damage;
(f) minimizing transient frequencies; and
(g) displaying a final signal as an acoustic siren.

11. A method as recited in claim 10, wherein said Wavelet Transform Analysis further comprises allowing time and frequency localization so as to track changes in frequencies over time utilizing peak tracking algorithms.

12. A method as recited in claim 11, wherein said Empirical Mode Decomposition Analysis further comprises revealing underlying time-dependent frequency characteristics utilizing a sifting process and further comprising utilizing a stability indicator.

13. A method as recited in claim 12, wherein said Instantaneous Frequency Analysis further comprises extracting dominant frequency mode by linearly fitting instantaneous phase angle.

14. A method as recited in claim 13, wherein said Instantaneous Frequency Analysis further comprises extracting dominant frequency mode by low-pass filtering of a instantaneous frequency curve.

15. A structural stability monitoring system constructed so as to monitor the stability of a structure in real-time, said system comprising a stability monitoring device and a mounting plate, said plate constructed so as to affix said stability monitoring device of said system to a structure.

16. A system as recited in claim 15, wherein said mounting plate comprises pre-formed apertures, said plate constructed so as to limit sensor damage during installation, allow for rapid mounting of said plate and allow for rapid removal of said device.

17. A system as recited in claim 16, wherein said plate has a thickness that is constructed so as to resonate above 100 Hz.

18. A system as recited in claim 17, wherein said mounting plate comprises a heat resistant ceramic layer.

19. A system as recited in claim 17, wherein said plate comprises a flame retardant plastic constructed so as to withstand temperatures up to 400° F.

20. A system as recited in claim 17, and further comprising thermal insulation constructed so as to insulate said plate from said structure.
